(19) United States
(12) Patent Application Publication
(10) Pub. No.: US 2002/0161158 A1
(43) Pub. Date: Oct. 31, 2002

(54) Process for working-up polyethersiloxanes

(76) Inventors: Georg Burkhart, Essen (DE); Wilfried Knott, Essen (DE); Volker Mohring, Mulheim (DE)

Correspondence Address: William F. Lawrence, Esq., c/o FROMMER LAWRENCE & HAUG LLP, 745 Fifth Avenue, New York, NY, 10151, US

(21) Appl. No.: 10/083,763

(22) Filed: Feb. 25, 2002

(30) Foreign Application Priority Data
Feb. 27, 2001 (DE) 101 09 419.1

(51) Int. Cl. C08G 77/00

(52) U.S. Cl. 528/10

(57) ABSTRACT

The invention relates to a process for working up polysiloxane/polyoxyalkylene block copolymers, wherein said copolymers are subjected to a treatment with superheated steam.

### RELATED APPLICATIONS

This application claims priority under 35 U.S.C. § 119 to German application 101 09 419.1, filed Feb. 27, 2001, herein incorporated by reference.

### BACKGROUND OF THE INVENTION

1. Field of the Invention

Organomodified siloxanes, in particular polysiloxane/ polyoxyalkylene block copolymers, are widely used compounds in virtually all areas in which control of surface-active behavior is important. The range of use of this class of substances is based not least on the possibility of establishing a variety of action principles in a controlled manner by a suitable combination of siloxane skeleton and polyethers as substituents.

The standard reaction for the organomodification of hydrogen siloxanes is platinum-metal catalyzed hydrosilylation. The industrial synthesis of the Si—C-linked polysiloxane/polyoxyalkylene block copolymer is based to a considerable extent on the use of the readily available allylpolyether.

In the case of the polyether-modified siloxanes, prepared by the process described above from allylpolyethers and hydrogen siloxanes, considerable excess amounts of the polyether components are used in some cases to ensure a quantitative SiH conversion and hence to avoid evolution of H₂ from the end product. This procedure is explained by the fact that, in addition to the desired Si—C linkage, varying degrees of isomerization of the allylpolyether used to give the corresponding, thermodynamically more stable propenylpolyether are observed. The propenylpolyether is not accessible to an Si—C linkage under the customary conditions of hydrosilylation.

However, undesired properties of the polysiloxane/polyoxyalkylene block copolymer result from the presence of propenylpolyether. Under the influence of traces of acid and moisture, the propenylpolyether undergoes hydrolysis; in other words, propionaldehyde is liberated over a certain period. As a result of secondary reactions, linear and/or cyclic oligomers (aldoxanes, trioxanes) also readily form from the propionaldehyde and have a tendency to cleavage and hence for the liberation of aldehyde again. Products which are required to have a neutral odor (for example for applications in the cosmetics sector) require an aftertreatment.

Moreover, if compounds carrying hydroxyl groups (for example, siloxane-bonded polyetherols) are contained in the aldehyde-contaminated system, then acetals, which may distort the physicochemical property profile of the desired product (for example by increasing the viscosity as a result of the increase in molar mass, etc.), may readily form.

2. Description of the Related Art

The prior art discloses very different methods for avoiding or eliminating the problems described in the case of allylpolyether-based systems:

EP-A-0 118 824 describes organopolysiloxane/polyoxyalkylene copolymers as oils for cosmetic purposes, having a total content of compounds carrying carbonyl groups (aldehydes+ketones) of ≦100 ppm and a peroxide content of ≦5 milliequivalents/kg of substance, which are obtainable by using antioxidants in amounts of 5-1 000 ppm, if required in the presence of a buffer during the hydrosilylation linkage reaction of allylpolyethers which are already very pure.

JP-A-07304627 teaches a process for the treatment of polyethersiloxanes by mixing them with aqueous hydrochloric acid at 60° C. in the course of 24 hours. The aldehyde content obtained is ≦100 ppm and the odor test is negative.

A comparable procedure for the acid-induced hydrolysis of propenylpolyether moieties with liberation, and the consequently possible removal of propionaldehyde is described in J. Soc. Cosmet. Chem. Japan (1993), 27(3), 297-303.

DE-A-41 16 419 relates to the elimination of undesired odor sources in the polysiloxane/polyoxyalkylene block copolymer by heterogeneously catalyzed hydrogenation under pressure over nickel/kieselguhr catalysts, colorless transparent products without a penetrating odor being obtained, which are stable in the aqueous acidic system and in a pH range of from 3 to 4 for a period of 6 weeks.

EP-A-0 398 684 describes the preparation of polyoxyalkylene/silicone block copolymers having little odor by reacting a hydrogen siloxane with allylpolyethers in ethanol under Pt catalysis and treating the reaction mixture with a dilute hydrochloric acid solution at elevated temperatures for a few hours and then subjecting it to a vacuum distillation, a virtually odorless copolymer being obtained.

The prior art furthermore describes the possibility of suppressing undesired odor in polysiloxane/polyoxyalkylene block copolymers by adding small amounts of phytic acid, which however remains in the system (JP-A-60018525).

The indirect routes taken to avoid the problems resulting from the allylpolyether isomerization are disclosed, for example, in EP-A-0 308 260, which claims a process for the preparation of highly pure oxyalkylene-modified organopolysiloxanes using vinyloxy-terminated polyethers. Because of limited availability and high raw material costs, this preparation route cannot be extended as desired.

JP-A-09012723, too, makes use of an avoidance strategy which replaces the hydrogen atoms in position 3 of the polyether-bonded allyl group by hydrocarbon substituents. Of course, a system modified in this way does not suffer from any allyl-propenyl rearrangement during the hydrosilylation.

On evaluating all these processes, it is found that no process is suitable for use for all polysiloxane/polyoxyalkylene block copolymers in a very wide range of applications. Additives inherent in the system, such as antioxidants and complexing acids (phytic acid), prevent the use of the copolymers treated in this manner in various applications, for example in the cosmetics or paint sector. Processes such as the heterogeneously catalyzed hydrogenation under pressure are complicated and expensive and hence acceptable only for small-volume, high-priced application areas of the silicone polyethers. If in particular those polyetherpolysiloxanes which are used in the form of foam stabilizers in the preparation of polyurethane foams and have a complex structure are included in this consideration, insufficiencies of an acid treatment or of a combined acid/alcohol treatment of the corresponding block copolymers are also evident.

Attempts to treat these functional surfactants with acid under moderate conditions illustrate the disastrous effect of this method on the suitability for use as foam stabilizers, in particular in hot flexible foam systems. Instead of the desired foam stabilization, a collapse of the labile foam structure is observed.

JP-A-09095536 is concerned with the preparation of highly pure siloxanes containing oxyalkylene groups as modifiers for polyurethanes. The adducts of very short-chain allyl-ethyleneoxy-propyleneoxy-ethers having (M≦250 g/mol) with hydrogen siloxanes are considered here. After the end of the addition reaction, the crude product is subjected to a treatment with stripping gas at 150° C. and reduced pressure (5 mmHg). These conditions are sufficient for virtually completely removing unconverted low molecular weight ethers, such as, for example, propylene glycol monoallyl ether, from the end product. In the case of the polysiloxane/polyoxyalkylene block copolymers whose polyether base comprises molar masses of about 400-10 000 g/mol, however, propenyl-containing moieties cannot be eliminated permanently and completely in this manner.

### OBJECTS OF THE INVENTION

It is an object of the present invention to provide an economical and gentle process for working up, in particular for purifying, polysiloxane/polyoxyalkylene block copolymers, which leads to virtually permanently odorless and low-emission products which moreover are improved in their performance characteristics. In particular, it is the object of an invention to provide a purification process for polysiloxane/polyoxyalkylene block copolymers which fulfill the stringent criteria of hot flexible foam stabilizers.

### DESCRIPTION OF THE INVENTION

It has surprisingly been found that, with the aid of the present invention, polysiloxane/polyoxyalkylene block copolymers can be freed from odor-forming impurities and cyclic siloxanes (D₄, D₅, D₆) in a gentle and permanent manner by treatment with superheated steam. In addition, it was not foreseeable that a gain in performance, especially in the case of the stabilizer systems used in the hot flexible foam, is also associated with this method of deodorization.

This is all the more surprising since it is known that propionaldehyde, which has a substantial proportion of the odor-forming factors, is water-soluble, as is known, for example, from CRC Handbook of Chemistry and Physics, 56th Edition, 1975-1976, page C-439 and D-32. If, moreover, the fact, disclosed in Römpp's Chemielexikon, 10th Edition, page 4936, key word “Wasserdampfdestillation” [Steam distillation], that usually only water-insoluble or poorly soluble components can be subjected to a transport reaction with steam distillations is taken into account, the result of the present invention is all the more surprising.

Accordingly, a first embodiment of the present invention comprises subjecting polysiloxane/polyoxyalkylene block copolymers to a treatment with superheated steam.

In the context of the present invention, Si—C-linked polyethersiloxanes are particularly preferably subjected to the superheated steam treatment according to the invention since they have a lower tendency to hydrolysis than Si—O—C-linked polyethersiloxanes and moreover are prepared by another route. By means of kinetic control, however, these polyethersiloxanes too can be worked up according to the invention.

Surprisingly, it has furthermore been found that this process is not limited to specific polyether terminal groups. Thus, for example, in addition to hydroxyl-terminated polyethersiloxanes, those which have been alkyl ether-endcapped or esterified, for example with acetyl groups, are also suitable. Here too, a hydrolytic cleavage reaction to be expected per se does not occur.

The source of the superheated steam is only of secondary importance. Thus, for example, it is possible to pass the superheated steam directly through the liquid polysiloxane/polyoxyalkylene block copolymer. In an analogous manner, however, it is also possible to add water to the siloxane and to expel the odor-forming components, such as, for example, propionaldehyde, if necessary with stirring and heating.

If, for example, polysiloxane/polyoxyalkylene block copolymers which have different polyoxyalkylene blocks in the average molecule (EP-B1-0 585 771) are subjected to a treatment with steam, a considerable amount of propionaldehyde is expelled from the copolymer. At the same time, the content of siloxane cycles (D₄, D₅, D₆) also decreases. In association with the decrease in concentration of volatile components, not only is an increase in the activity of the treated foam stabilizer observed but its tendency to control a finely cellular polymer foam is also increased.

The claimed process comprises both the possibility of passing superheated steam into the polysiloxane/polyoxyalkylene block copolymer to be freed from volatile components and odor and the option of carrying out in situ evaporation of water in the hot polysiloxane/polyoxyalkylene block copolymer to be treated. Thus, the process of the invention provides the possibility of locating the steam source outside or inside the reaction vessel.

A further practical embodiment for the treatment of siloxane/polyoxyalkylene block copolymers with superheated steam comprises, for example, the use of binary nozzles. Here, optionally heated silicone polyether and superheated steam in the form of micronized spray mists are caused to undergo intense mass transfer and the vapor phase laden with volatile substances, and the purified product, can then be separated from one another optionally with the use of a demister.

In the examplary embodiments, performance characteristics of the polysiloxane/polyoxyalkylene block copolymers purified by the process according to the invention are described in more detail.

### EXAMPLES

### Reference Example

Preparation of the polysiloxane/polyoxyalkylene block copolymer to be worked up

7.5 g (=0.0125 mol) of a polyether having the average formula

CH₂═CH—CH₂O—(C₂H₄O—)₁₂CH₃ (type A)

301.8 g (=0.075 mol) of a polyether having the average formula

CH₂═CH—CH₂O—(C₂H₄O)₄₅(C₃H₆O—)₃₄CH₃ (type B)

56.6 g (=0.0375 mol) of a polyether having the average formula

CH₂═CH—CH₂O—(C₂H₄O—)₅(C₃H₆O—)₂₁CH₃ (type C)

and 16 mg of C₂H₄C₅H₅N.PtCl₂ were initially introduced into a flask which had been provided with a dropping funnel, stirrer, thermometer, gas inlet line and reflux condenser. Nitrogen was passed through the apparatus. After heating up to 120° C., 65.5 g (=0.1 mol of SiH) of a siloxane having the average formula

H(CH₃)₂SiO—[(CH₃)₂SiO—]₈₀[(CH₃)HSiO—]₈Si(CH₃)₂H

were added dropwise. The reaction was allowed to continue for a further 2.5 hours. The SiH conversion was 99.4%.

After filtration over a Seitz-K-300 filter disk, a clear, slightly yellowish product characterized by a strong propionaldehdye odor was obtained.

### Examplary Embodiment 1

Purification of the polysiloxane/polyoxyalkylene block copolymer obtained in the reference example

200 g of the copolymer described in the preparation example were initially introduced into a 11 multi-necked round-bottomed flask with vigorous stirring at 120° C. and were treated over a period of 15 minutes with a stream of steam at 150° C. (measured 20 cm before the steam outlet) via a gas inlet tube (vaporized H₂O mass=160 g).

The stream of steam and volatile substances leaving the flask was condensed with the aid of an attached distillation bridge, and the condensate was collected in downstream receivers.

The mass of volatile components expelled was 4.05 g.

After the end of the steam treatment, the polysiloxane/polyoxyalkylene block copolymer was freed from any condensation water residues at elevated temperatures by briefly applying an auxiliary vacuum (15 mmHg).

The polysiloxane/polyoxyalkylene block copolymer was obtained as a clear, odorless liquid. GC analysis showed the following purification effect:

| | Crude | Steam-treated |
|---|---|---|
| | polyethersiloxane | polyethersiloxane |
| GC components | (reference example) | (Examplary embodiment 1) |
| Free propionaldehdye* | 30 ppm | <1 ppm |
| D₄ | 0.8% | <0.1% |
| D₅ | 0.4% | <0.1% |
| D₆ | 0.1% | <0.1% |

*Free propionaldehyde was determined by means of headspace gas chromatograph using a concentration method (solution in benzyl alcohol)

Testing of the performance characteristics of the foam stabilizers prepared was carried out using a foam formulation in the following manner:

In each case 300 parts of a commercial polyether which was intended for the preparation of flexible polyurethane foams, had three hydroxyl groups in the average molecule and had a molecular weight of 3 500 were mixed with 15 parts of water, 15 parts of a commercial physical blowing agent, the corresponding amount of the foam stabilizer to be investigated, 0.33 part of diethylenetriamine and 0.69 part of tin octanoate with thorough stirring. After the addition of 189 parts of tolylene diisocyanate (2,4 and 2,6 isomer mixture in the ratio of 4:1), stirring was effected with a Glatt stirrer for 7 seconds at 2 500 rpm and the mixture was poured into a box open at the top. A fine-pored foam which is characterized by the following parameters formed:

1. The sagging of the foam at the end of the rise phase (referred to as “sag” in the table below).

2. The number of cells per centimeter of foam which were determined microscopically.

The table below compares the measured values for 2 different concentrations (1.8 parts/1.5 parts) of the stabilizer obtained by the reference example and by examplary embodiment 1:

| Example | Sag | Cells per centimeter |
|---|---|---|
| Reference example | 0.9/2.0 | 13/12 |
| Examplary embodiment 1 | 0.7/1.4 | 16/15 |

This comparison documents the improvement in performance characteristics which the process according to the invention opens up for stabilizers for flexible polyurethane foams.

In addition to the elimination of an undesired odor and the reduction of free siloxane cycles, the foam stabilizer gained both in terms of the activity and from the point of view of increased fine cell content.

Empirical observation has shown clearly detectable, persistent spraying on the foam surface on going from the cream phase to the rise phase in the case of coarsening of the foam. When the polysiloxane/polyoxyalkylene block copolymers treated according to the invention were used, this characteristic spraying was not observed.

### Comparative Example

In analogy to the process disclosed in JP-A-09095536, the polysiloxane/polyoxyalkylene block copolymer obtained according to the reference example was subjected to a two-hour treatment with N₂ as stripping gas at 150° C. and reduced pressure (5 mmHg).

The proportion of volatile components which were stripped out by this process was 3.7%. The product obtained had a substantially stronger color than the starting material and still had a penetrating aldehyde odor. The GC headspace analysis indicated a concentration of 5 ppm of free propionaldehyde.

The evaluation of the performance characteristics as a foam stabilizer gives the following picture:

| Example | Sag | Cells per centimeter |
|---|---|---|
| Comparative example | 0.9/1.5 | 15/14 |
| Examplary embodiment 1 | 0.7/1.4 | 16/15 |

### Examplary Embodiment 2

180.5 g of a polysiloxane/polyoxyalkylene block copolymer obtained from analogous raw materials and having a structure type analogous to that in the reference example were initially introduced into a multi-necked round-bottomed flask having a stirrer and attached distillation bridge at 120° C. and were treated with steam at 155° C. via an inlet tube for 30 minutes. 2.8 g of volatile components were expelled and were condensed in a downstream receiver.

Analogously to examplary embodiment 1, the untreated polysiloxane/ polyoxyalkylene block copolymer and the steam-treated material were evaluated as a foam stabilizer. The use of untreated copolymer as foam stabilizer gave a flexible foam having 9 cells/cm; treated material on the other hand ensured 13 cells/cm.

This example shows that the process according to the invention makes it possible to prepare a product having an acceptable property profile from a flexible foam stabilizer which is not very suitable per se.

The above description is intended to be illustrative and not limiting. Various changes and modifications in the embodiment described herein may occur to those skilled in the art. Those changes can be made without departing from the scope or spirit of the invention.

Patent claims:

1. A process for removing impurities from a polysiloxane/polyoxyalkylene block copolymer which comprises treating a polysiloxane/polyoxyalkylene block copolymer containing said impurities with superheated steam.

2. The process according to claim 1, wherein the superheated steam is dry superheated steam.

3. The process according to claim 1, wherein the impurities are cyclic siloxanes.

4. The process according to claim 1, wherein the impurities are propionaldehyde.

5. The process according to claim 1, wherein the steam is generated in situ.

6. The process according to claim 1, wherein a binary nozzle is used to treat the polysiloxane/polyoxyalkylene block copolymer with superheated steam.

7. The process according to claim 1, wherein water is first added to the polysiloxane/polyoxyalkylene block copolymer containing impurities before treating said impurities with steam.

8. A polysiloxane/polyoxyalkylene block copolymer obtainable by the process according to claim 1.

9. A method for removing odors from a polysiloxane/polyoxyalkylene block copolymer which comprises treating a polysiloxane/polyoxyalkylene block copolymer with superheated steam.

10. A foam stabilizer which comprises a polysiloxane/polyoxyalkylene block copolymer according to claim 8.

11. A method for preparing a fine-pored polyurethane foam which comprises adding a foam stabilizer according to claim 10 to a mixture comprising polyurethane foam precursors.

12. A process for preparing a flexible polyurethane foam which comprises reacting a polyol and an isocyanate in the presence of a foam stabilizer, wherein the foam stabilizer comprises a polysiloxane/polyoxyalkylene block copolymer, whereby the polysiloxane/polyoxyalkylene block copolymer first has been purified by reacting said polysiloxane/polyoxyalkylene block copolymer with superheated steam.

13. A polysiloxane/polyoxyalkylene block copolymer wherein said polysiloxane/polyoxyalkylene block copolymer has, as impurities, less than 1 ppm of propionaldehyde and less than 0.1% of D₄, D₅ or D₆ cyclic siloxanes.
